(19) United States
(12) Patent Application Publication
(10) Pub. No.: US 2004/0005114 A1
(43) Pub. Date: Jan. 8, 2004

(54) Electrostatic drive mirror apparatus

(75) Inventors: Yohei Sakai, Ina-shi (JP); Masanori Ogata, Matsumoto-shi (JP); Kazuya Matsumoto, Nagano-ken (JP); Hiromasa Fujita, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: OLYMPUS OPTICAL CO., LTD., Tokyo (JP)

(21) Appl. No.: 10/609,606

(22) Filed: Jul. 1, 2003

(30) Foreign Application Priority Data
Jul. 3, 2002 (JP) 2002-194064

(51) Int. Cl. G02B 6/35

(52) U.S. Cl. 385/18

(57) ABSTRACT

Disclosed herein is an electrostatic drive mirror apparatus including: electrostatic drive mirrors to be variably operated by electrostatic drive; an electrostatic mirror drive section formed on one semiconductor substrate, including at least mirror drive electrodes for driving the electrostatic drive mirrors and signal wirings for applying drive voltage on the mirror drive electrodes; a variable voltage source for supplying voltage from an external source to the electrostatic mirror drive section; drive switches for controlling and driving applied voltages from the variable voltage source to the electrostatic mirror drive section; holding capacitors for retaining the applied voltage to the electrostatic mirror drive section; and a control section for controlling at least the drive switches and the variable voltage source.

This application claims benefit of Japanese Patent Application No. 2002-194064 filed in Japan on Jul. 3, 2002, the contents of which are incorporated by this reference.

### BACKGROUND OF THE INVENTION

The present invention relates to electrostatic drive mirror apparatus for use for example in optical switches.

Some examples of configuration of the conventional electrostatic drive mirror apparatus (also referred to as: electrostatic micromachine mirror) will be described below with reference to FIGS. 1 and 2. Shown in FIG. 1 is an optical crossconnect system using micromachine mirrors as disclosed in Japanese patent application laid-open No.2001-117025. Referring to FIG. 1, numeral 100 denotes an optical crossconnect (Optical Crossconnect, OXC) fabric including an imaging (image forming) lens array 101, mirror array 102 and reflector 103, typically formed by Micro Electro-Mechanical System (MEMS) technology. While, for ease of explanation, it is shown here as one having four units of I/O fiber and mirror, the optical crossconnect (OXC) fabric 100 can have an optional number of I/O fibers and mirrors, specifically such as 16×16 array or 256 units of fiber and mirror.

The imaging lens array 101 consists of lenses 105a to 105d respectively adjusted with I/O fibers 104a to 104d, and the mirror array 102 consists of a plurality of mirrors 106a to 106d corresponding to the I/O fibers 104a to 104d, respectively. The imaging (image forming) lenses 105a to 105d correspond to the I/O fibers 104a to 104d, respectively, and focus (form images of) optical signals transmitted between I/O fibers 104a to 104d and the respective mirrors 106a to 106d of the mirror array 102. Each of the mirrors 106a to 106d of the mirror array 102 is connected to a controller 108 which controls the inclination of these mirrors so that signals from one I/O fiber be routed to another I/O fiber.

The mirrors 106a to 106d are formed through torsion spring 107 by means of biaxial flexible gimbal mount using the Micro Electro-Mechanical System (MEMS) technology. Each mirror 106a to 106d is capable of being inclined in response to voltage signals by ±5 degree with respect to each axis. For example, in order to route an input signal from I/O fiber 104a to I/O fiber 104c, the mirrors 106a and 106c are inclined so that the input signal from I/O fiber 104a is reflected by the mirror 106a to be directed toward the reflector 103 and then reflected by the reflector 103 to be directed toward the mirror 106c and then is directed toward I/O fiber 104c from the mirror 106c. By such method, optional two I/O fibers are connected by signal to each other.

FIG. 2 shows in detail a mirror array to be used in the optical crossconnect system as disclosed in Japanese patent application laid-open No.2001-174724. Referring to FIG. 2, a mirror array 110 is formed of a plurality of inclinable mirrors 112 each mounted on spring 111 and controlled by electrodes (not shown). Each inclinable mirror 112 has a size of 100 to 500 μm, formed in the shape for example of a rectangle, circle or ellipse and is caused to turn around X-Y axes, i.e., inclined by an angle of inclination to be determined by voltages applied to the electrodes.

According to the above construction, various optical crossconnect fabric is constructed in a compact size by using one or plural MEMS inclinable mirror arrangement together with an arrangement of lenses. In other words, one can be achieved as having smallest space between the component elements of the crossconnect fabric and smallest optical power loss.

### SUMMARY OF THE INVENTION

It is an object of the present invention to provide an electrostatic drive mirror apparatus in which electrostatic drive mirrors are provided with self-retaining characteristic and which is capable of stable and reliable operation as a result that the number of drive voltage sources is greatly reduced. It is another object of the invention to provide an electrostatic drive mirror apparatus which can be reduced in size and be readily manufactured and of which packaging cost can be greatly reduced.

In a first aspect of the electrostatic drive mirror apparatus according to the invention, there is provided an electrostatic drive mirror apparatus including: electrostatic drive mirrors to be variably operated by electrostatic drive; an electrostatic mirror drive section formed on one semiconductor substrate, including at least mirror drive electrodes for driving the electrostatic drive mirrors and signal wirings for applying drive voltage on the mirror drive electrodes; a variable voltage source for supplying voltage from an external source to the electrostatic mirror drive section; drive switches for controlling and driving applied voltages from the variable voltage source to the electrostatic mirror drive section; holding capacitors for retaining the applied voltage to the electrostatic mirror drive section; and a control section for controlling at least the drive switches and the variable voltage source.

In a second aspect of the invention, the drive switches, holding capacitors and control section of the electrostatic drive mirror apparatus according to the first aspect are provided externally to the electrostatic mirror drive section.

In a third aspect of the invention, the drive switches, holding capacitors and control section of the electrostatic drive mirror apparatus according to the second aspect are respectively formed as a discrete member.

In a fourth aspect of the invention, the drive switches, holding capacitors, and at least a part of the control section of the electrostatic drive mirror apparatus according to the second aspect are disposed on the same one semiconductor substrate.

In a fifth aspect of the invention, the drive switches and control section of the electrostatic drive mirror apparatus according to the first aspect are provided externally to the electrostatic mirror drive section, and the holding capacitors are disposed on the same one semiconductor substrate with the electrostatic mirror drive section.

In a sixth aspect of the invention, the drive switches and control section of the electrostatic drive mirror apparatus according to the fifth aspect are respectively formed as a discrete member.

In a seventh aspect of the invention, the drive switches and at least a part of the control section of the electrostatic drive mirror apparatus according to the fifth aspect are disposed on the same one semiconductor substrate.

In an eighth aspect of the invention, the drive switches and holding capacitors of the electrostatic drive mirror apparatus according to the first aspect are disposed on the same one semiconductor substrate with the electrostatic mirror drive section, and the control section is provided externally to the electrostatic mirror drive section.

In a ninth aspect of the invention, the drive switches and holding capacitors and at least a part of the control section of the electrostatic drive mirror apparatus according to the first aspect are disposed on the same one semiconductor substrate with the electrostatic mirror drive section.

In a tenth aspect of the invention, the holding capacitors of the electrostatic drive mirror apparatus according to any one of the fifth to ninth aspects are disposed underneath the signal wirings of the electrostatic mirror drive section.

In an eleventh aspect of the invention, the holding capacitors of the electrostatic drive mirror apparatus according to any one of the fifth to ninth aspects are disposed underneath the mirror drive electrodes of the electrostatic mirror drive section.

In a twelfth aspect of the invention, the electrostatic drive mirror apparatus according to any one of the first to ninth aspects further includes: a control logic circuit having a function for effecting control to close the drive switches all together; a discharging switch for discharging accumulated charges of the holding capacitors; and a limiting resistor for limiting discharging current.

In a thirteenth aspect of the invention, the electrostatic drive mirror apparatus according to the tenth aspect further includes: a control logic circuit having a function for effecting control to close the drive switches all together; a discharging switch for discharging accumulated charges of the holding capacitors; and a limiting resistor for limiting discharging current.

In a fourteenth aspect of the invention, the electrostatic drive mirror apparatus according to the eleventh aspect further includes: a control logic circuit having a function for effecting control to close the drive switches all together; a discharging switch for discharging accumulated charges of the holding capacitors; and a limiting resistor for limiting discharging current.

In a fifteenth aspect of the invention, an electrostatic drive mirror apparatus is constituted by arranging a plurality of units, each unit being the electrostatic drive mirror apparatus according to any one of the first to ninth aspects.

In a sixteenth aspect of the invention, an electrostatic drive mirror apparatus is constituted by arranging a plurality of units, each unit being the electrostatic drive mirror apparatus according to the tenth aspect.

In a seventeenth aspect of the invention, an electrostatic drive mirror apparatus is constituted by arranging a plurality of units, each unit being the electrostatic drive mirror apparatus according to the eleventh aspect.

In an eighteenth aspect of the invention, an electrostatic drive mirror apparatus is constituted by arranging a plurality of units, each unit being the electrostatic drive mirror apparatus according to the twelfth aspect.

In a nineteenth aspect of the invention, an electrostatic drive mirror apparatus is constituted by arranging a plurality of units, each unit being the electrostatic drive mirror apparatus according to the thirteenth aspect.

In a twentieth aspect of the invention, an electrostatic drive mirror apparatus is constituted by arranging a plurality of units, each unit being the electrostatic drive mirror apparatus according to the fourteenth aspect.

### BRIEF DESCRIPTION OF THE DRAWINGS

FIG. 1 schematically shows an example of construction of the conventional electrostatic drive mirror apparatus.

FIG. 2 schematically shows another example of construction of the conventional electrostatic drive mirror apparatus.

FIG. 3 is a perspective view showing a principal portion of general construction of the electrostatic drive mirror apparatus to which the invention is applied.

FIG. 4 schematically shows a first embodiment of the invention.

FIG. 5 schematically shows a second embodiment of the invention.

FIG. 6 schematically shows a principal portion of a third embodiment of the invention.

FIG. 7 shows a principal portion of a modification of the third embodiment shown in FIG. 6.

FIG. 8 illustrates a typical construction of the holding capacitor in the third embodiment and modification thereof shown in FIGS. 6 and 7.

FIG. 9 schematically shows an overall construction of modification of the third embodiment shown in FIG. 7.

FIG. 10 schematically shows a fourth embodiment of the invention.

FIG. 11 schematically shows a fifth embodiment of the invention.

FIG. 12 schematically shows a modification of the fifth embodiment shown in FIG. 11.

FIG. 13 schematically shows a sixth embodiment of the invention.

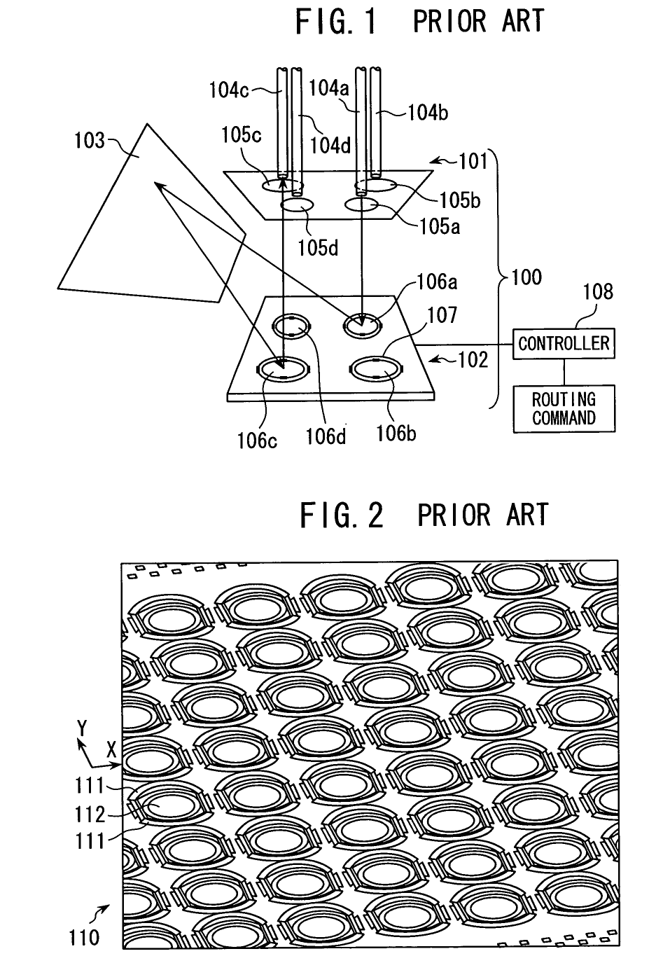

### DESCRIPTION OF THE PREFERRED EMBODIMENTS

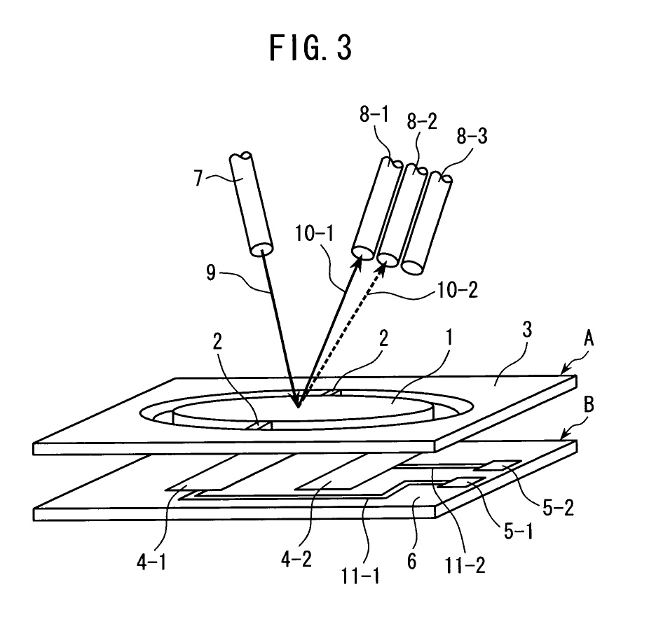

Some embodiments of the present invention will now be described. Before describing the embodiments in detail, a description will be first given by way of FIG. 3 with respect to general construction and operation of an electrostatic drive mirror to which the invention is applied. Referring to FIG. 3, the electrostatic drive mirror includes a mirror board A and an electrode board B. The mirror board A includes: a mirror 1 for reflecting light, capable of being variably operated by electrostatic drive; hinges 2 for supporting the mirror 1; and a mirror support 3 for supporting these. The electrode board B, on the other hand, includes: mirror drive electrodes 4-1, 4-2 for generating electrostatic attraction; pad electrodes 5-1, 5-2 to be used in mounting to package; signal wiring 11 for electrically connecting the mirror electrodes 4-1, 4-2 and the pad electrodes 5-1, 5-2; and an electrode support 6 for supporting all of these. The mirror board A and electrode board B are then coupled to each other with a separation of desired distance to constitute the electrostatic drive mirror.

The operation of the electrostatic drive mirror having such construction will now be described. Referring to FIG. 3, when an incident light ray 9 coming from an input fiber 7 impinges upon the mirror 1, the impinging light ray 9 is reflected on the mirror 1 to become a reflected light 10-1 and then outputted to an output fiber 8-1. Here, the mirror 1 is variably driven by applying voltage to the mirror drive electrodes 4-1, 4-2. In other words, an inclination of the mirror 1 can be adjusted at will by the mirror drive voltage. Accordingly, an angle of the reflected light can also be controlled at will as indicated by 10-1, 10-2, by changing the mirror drive voltage to control an inclination angle of the mirror 1. It is thereby possible to output the reflected light to a desired one among the output fibers 8-1, 8-2, 8-3.

While, for ease of explanation, one using unidimensionally arranged fibers and uniaxially supported mirror has been shown in the above description, the fibers are usually arranged in two dimensions and the mirror is usually formed to have a biaxially supported construction. Accordingly, four drive electrodes are required for one mirror. Further, while one using the fibers for the inputting/outputting of light has been shown, a fixed mirror, variable mirror, or some other optical media other than fibers can also be used.

(First Embodiment)

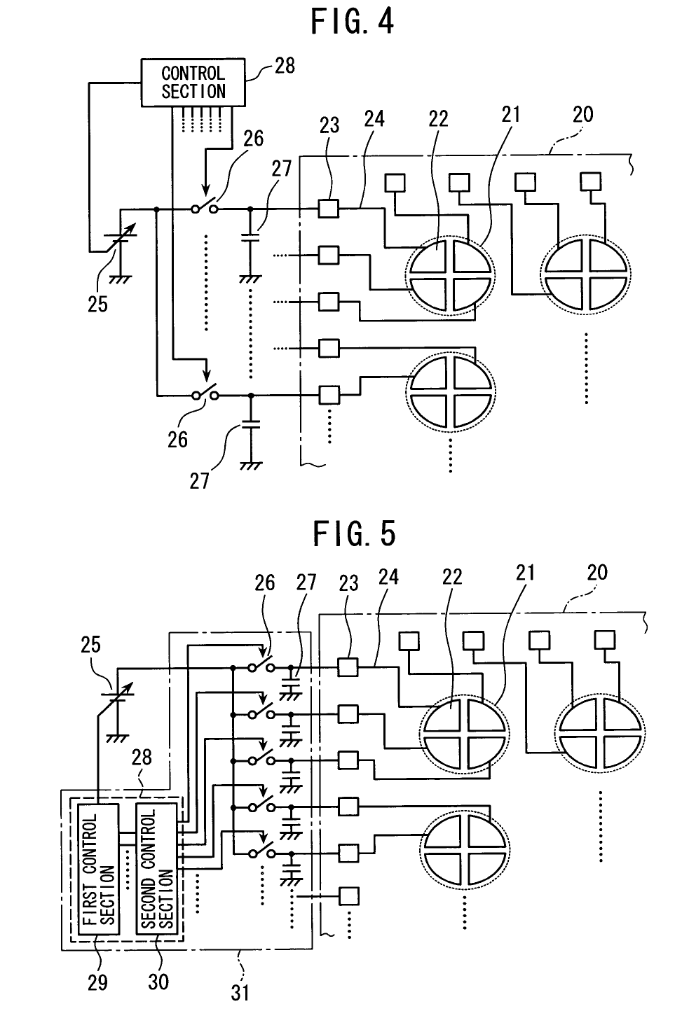

A description will now be given with respect to a first embodiment of the electrostatic drive mirror apparatus according to the invention. FIG. 4 schematically shows construction of the electrostatic drive mirror apparatus according to the first embodiment. Here, for ease of explanation, only a principal portion thereof is shown. FIG. 4 includes: 21, electrostatic drive mirrors that are two-dimensionally arrayed and variably operated by electrostatic drive; 22, mirror drive electrodes for driving the electrostatic drive mirrors 21; 23, pad electrodes for applying drive voltages from an external source; 24, signal wiring for electrically connecting the mirror drive electrodes 22 and pad electrodes 23 to transmit drive signals to the mirror drive electrodes 22. Four mirror drive electrodes 22 are disposed to drive one electrostatic drive mirror 21. Accordingly, there is one-to-one correspondence between the pad electrodes 23 and mirror drive electrodes 22 so that the number of pad electrodes is four times that of the electrostatic drive mirrors 21. Here, the mirror drive electrodes 22, pad electrodes 23, and signal wiring 24 are formed on one semiconductor substrate 20 as an electrostatic mirror drive section. The electrostatic mirror drive section is coupled to the electrostatic drive mirror 21 with a separation of predetermined distance. Thus coupled electrostatic mirror drive section and electrostatic drive mirror are referred to as an electrostatic mirror chip.

Formed as external component members at the outside of the electrostatic mirror chip are: a variable voltage source 25 for supplying drive voltage to the electrostatic mirror drive section; drive switches 26 for controlling and driving the applied drive voltage to the pad electrodes 23 in one-to-one correspondence with the pad electrodes 23; holding capacitor 27 for holding the applied drive voltage; and a control section 28 for controlling the variable voltage source 25 and drive switches 26. These external component members and the electrostatic mirror chip constitute an electrostatic drive mirror apparatus. It should be noted that, in this configuration, the drive switches 26, holding capacitor 27, variable voltage source 25 and control section 28 are respectively formed as a discrete member.

The electrostatic drive mirror apparatus having such construction is driven as follows. First, the voltage setting of the variable voltage source 25 and the switching of drive switches 26 are controlled by the control section 28 to apply the drive voltage of the electrostatic drive mirror 21 to the pad electrodes 23 of the electrostatic mirror chip. Here the holding capacitor 27 provided between the drive switch 26 and the pad electrode 23 restrains voltage drop at the time of the switching of the drive switch 26 and retains the drive voltage applied to the pad electrode 23 for a certain time period. A stable drive voltage is thereby supplied to the mirror drive electrode 22 to maintain a posture of the electrostatic drive mirror 21.

These drive switch 26 and holding capacitor 27 are provided for each pad electrode 23, i.e., for each mirror drive electrode 22 so that an independent voltage can be stably supplied to each mirror drive electrode 22 from the common variable voltage source 25 by an intermittent switching of the drive switch 26 based on the method as described above.

By such construction, the posture of the electrostatic drive mirror 21 can be maintained even in a period during which a mirror drive voltage is not directly applied to the mirror drive electrode 22 from the variable voltage source 25, since the holding capacitor 27 has a holding/storing function of the drive voltage of the electrostatic drive mirror 21. In other words, it becomes possible to apply an intermittent mirror drive voltage to the mirror drive electrode 22 and at the same time to impart a self-retaining characteristic to the electrostatic drive mirror 21.

Further, since an intermittent voltage application to the mirror drive electrode 22 is possible, switching of the plurality of drive switches 26 is sequentially performed to apply the voltage set at the variable voltage source 25 to each mirror drive electrode 22 in accordance with the timing of such switching. The applied voltage to each mirror drive electrode 22 is thereby set to a desired voltage. Accordingly, the driving of the electrostatic drive mirror apparatus becomes possible even by one unit of variable voltage source. In other words, the number of variable voltage sources is not required to be the same as the number of the mirror drive electrodes and several units of the variable voltage sources at most are sufficient. In theory, the number can be reduced to one unit.

It should be noted that the electrostatic drive mirror apparatus having two-dimensionally arrayed electrostatic drive mirrors has been described in the above embodiment. The embodiment however is not limited to such and naturally can be applied also to those electrostatic drive mirror apparatus having unidimensionally arranged ones or a single unit of electrostatic drive mirror.

(Second Embodiment)

A second embodiment of the invention will now be described. This embodiment relates to the electrostatic drive mirror apparatus in which the drive switches, holding capacitor and control section are formed on the same one semiconductor substrate that is different from the electrostatic mirror chip. The electrostatic drive mirror apparatus according to this embodiment is shown in FIG. 5.

FIG. 5 includes: 21, electrostatic drive mirrors that are two-dimensionally arrayed and variably operated by electrostatic drive; 22, mirror drive electrodes for driving the electrostatic drive mirrors 21; 23, pad electrodes for applying drive voltages from an external source; 24, signal wiring for electrically connecting the mirror drive electrodes 22 and pad electrodes 23 to transmit drive signals to the mirror drive electrodes 22. Four mirror drive electrodes 22 are disposed to drive one electrostatic drive mirror 21. Here, the mirror drive electrodes 22, pad electrodes 23, and signal wiring 24 are formed as an electrostatic mirror drive section on the same one semiconductor substrate 20. The electrostatic mirror drive section is coupled to the electrostatic drive mirror 21 with a separation of predetermined distance. Thus coupled electrostatic mirror drive section and electrostatic drive mirror are referred to as an electrostatic mirror chip similarly to the first embodiment.

Formed as external component members at the outside of the electrostatic mirror chip are: a variable voltage source 25 for supplying drive voltage to the electrostatic mirror drive section; drive switches 26 for controlling and driving the applied drive voltage to the electrostatic drive mirrors 21; holding capacitor 27 for holding the applied drive voltage; and a control section 28 for controlling the variable voltage source 25 and drive switches 26. These external component members and the electrostatic mirror chip constitute an electrostatic drive mirror apparatus. Here, the control section 28 is constituted by a first control section 29 and a second control section 30. The first control section 29 is to control the variable voltage source 25 and the second control section 30 and for example contains D/A converter, high-voltage resisting amplifier, etc. The second control section 30, on the other hand, controls the drive switches 26. It is constituted for example by a shift register or decoder and is controlled by the first control section 29 which is synchronized. Further, the control section 28 is formed monolithically together with the drive switches 26 and holding capacitors 27 on one semiconductor substrate 31 that is different from the electrostatic mirror chip.

Application of drive voltage to the electrostatic mirror drive section is performed as follows. The variable voltage source 25 is controlled by the first control section 29 for controlling the variable voltage source in accordance with change in bits of the shift register or decoder of the second control section 30 for controlling the drive switches 26. The voltage of the variable voltage source 25 is thereby arbitrarily changed and at the same time the switching of the drive switches 26 is controlled by the shift register or decoder of the second control section 30. By such driving method, the drive voltage of the electrostatic drive mirror 21 can be applied as a desired voltage and at desired timing to the electrostatic mirror drive section, i.e., to the pad electrodes 23.

Accordingly, a remarkable downsizing is possible and the manufacturing method becomes easier as compared to the case where each of the component members other than the electrostatic mirror chip is constructed as a discrete member as in the first embodiment. It is thus possible to cause a stable operation of the electrostatic drive mirror 21 and its reliability is also improved. Further, application voltage can be supplied to a plurality of electrodes by a single unit of variable voltage source 25 by effecting control of the drive switches 26 by the shift register or decoder of the second control section 30.

It should be noted that the present embodiment has been shown as the case where the drive switches 26, holding capacitor 27 and control section 28 are provided on the same one semiconductor substrate. Depending on the construction of the control section, however, it is also possible to form only a part of the control section together with the drive switches and holding capacitor on the same one semiconductor substrate and to discretely form the rest of the control section. Alternatively, at this time, the rest of the control section can be constructed as formed on another semiconductor substrate. It is furthermore possible that only the drive switches and holding capacitor are formed on the same one semiconductor substrate while the control section is formed on a separate semiconductor substrate or constructed discretely.

Further, in the present embodiment, construction containing D/A converter and high-voltage resisting amplifier has been shown as the variable voltage source control section (first control section) and one constructed of a shift register or decoder as the drive switch control section (second control section). It is however not limited by these and, naturally, any of those having the function as the variable voltage source control section and drive switch control section can be used as the construction thereof.

(Third Embodiment)

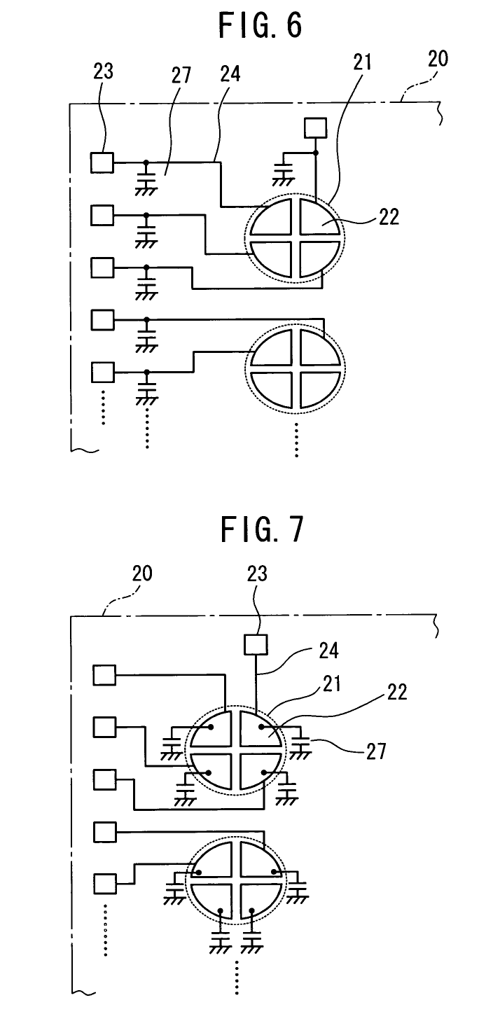

A third embodiment of the invention will now be described. In the present embodiment, the holding capacitor is provided within the electrostatic mirror chip. Only a principal portion within the electrostatic mirror chip of the electrostatic drive mirror apparatus according to the present embodiment and to a modification thereof is shown in FIGS. 6 and 7, respectively. The construction and driving manner of those other than the holding capacitor are similar to the first or second embodiment and a description thereof will be omitted.

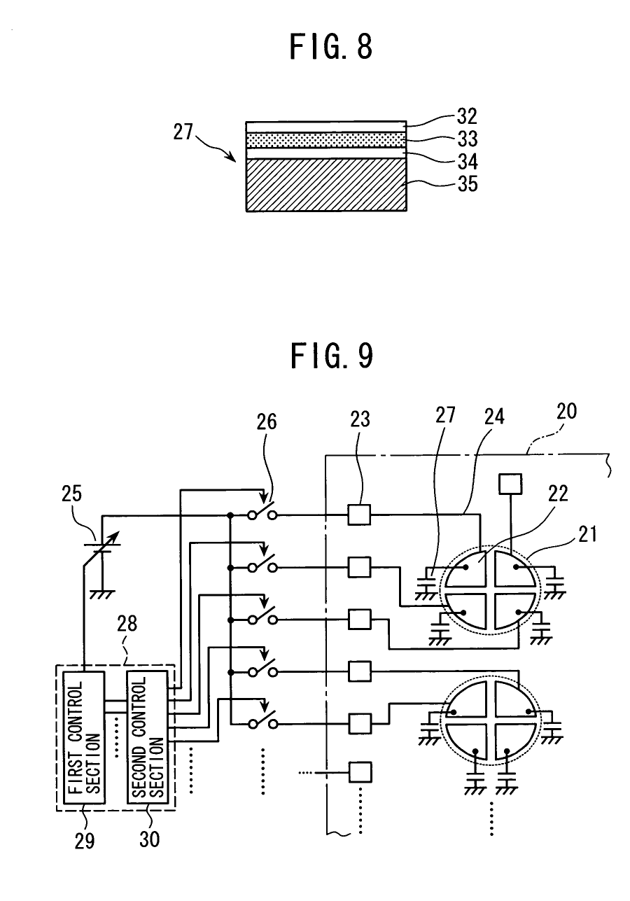

Referring to FIG. 6, a holding capacitor 27 is formed underneath a signal wiring 24 which is formed on the same one semiconductor substrate 20 together with the mirror drive electrode 22 and pad electrode 23 of the electrostatic mirror drive section. In FIG. 7, on the other hand, a holding capacitor 27 is formed underneath the mirror drive electrode 22. In both cases, as typically shown in FIG. 8, the holding capacitor 27 is formed by two pieces of metal electrodes 32, 34 and an insulating film 33 such as of SiO₂ or SiN inserted between the metal electrodes. Here, one metal electrode 32 is formed of such metal as Al or Ti which forms the signal wiring 24 or mirror drive electrode 22, and the other metal electrode 34 is formed of such metal as Al. Numeral 35 denotes a semiconductor substrate.

FIG. 9 schematically shows an overall construction of the electrostatic drive mirror apparatus according to the third embodiment having holding capacitor constructed within the electrostatic mirror chip as described above. Referring to FIG. 9, the holding capacitor 27 is formed underneath the mirror drive electrode 22, and the electrostatic mirror drive section containing the holding capacitor 27 is formed on one semiconductor substrate 20. The drive switches 26, control section 28 and variable voltage source 25, on the other hand, may be of any construction as far as their respective functions are provided. These are shown here as discrete members.

As described above, the holding capacitor is most suitably provided within the electrostatic mirror drive section that is formed on one semiconductor substrate. By providing the holding capacitor within the electrostatic mirror chip in this manner, a downsizing becomes possible and a reduction in costs is achieved as a result of reducing the number of externally attached component parts. Further a more stable operation and an improved reliability of the electrostatic drive mirror are expected.

(Fourth Embodiment)

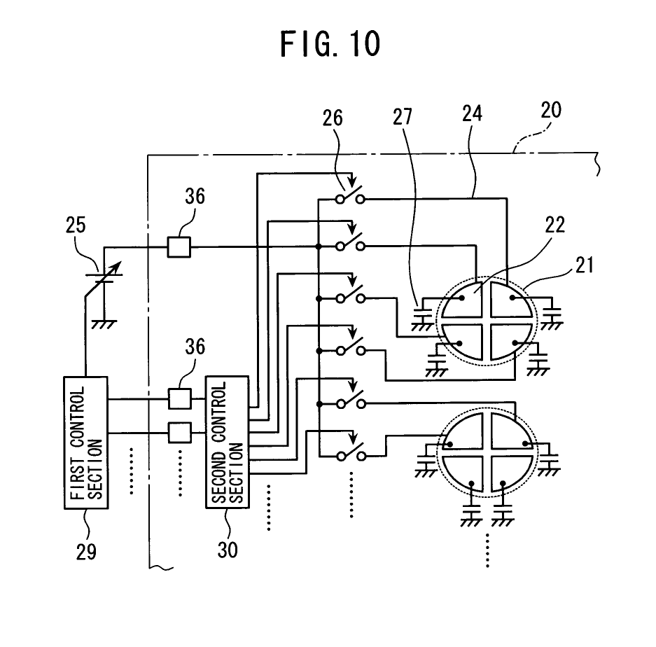

A fourth embodiment of the invention will now be described. The present embodiment relates to electrostatic drive mirror apparatus in which pad electrodes within the electrostatic mirror chip are made unnecessary so as to achieve downsizing. The electrostatic drive mirror apparatus according to the embodiment is shown in FIG. 10.

FIG. 10 includes: 21, electrostatic drive mirrors that are two-dimensionally arrayed and variably operated by electrostatic drive; 22, mirror drive electrodes for driving the electrostatic drive mirrors 21; and 24, signal wiring for transmitting drive signals to the mirror drive electrodes 22. Four mirror drive electrodes 22 are disposed to drive one electrostatic drive mirror 21. Numeral 25 denotes a variable voltage source for supplying drive voltage to the electrostatic mirror drive section, and numeral 26 denotes drive switches for controlling and driving applied drive voltage. Numeral 27 denotes a holding capacitor for holding applied drive voltage, formed underneath the mirror drive electrodes 22. Numeral 29 denotes a first control section for controlling the variable voltage source 25 and a second control section; 30 denotes the second control section such as of a shift register or decoder for controlling the drive switches 26; and 36 denotes pad electrode for transmitting voltage of the variable voltage source to the drive switches and pad electrodes for connecting the first control section 29 and the second control section 30 to each other. Here all of these except the variable voltage source 25 and first control section 29 are formed on one semiconductor substrate 20. The driving manner of the electrostatic drive mirror apparatus according to the fourth embodiment is similar to the foregoing embodiments.

In the fourth embodiment having such construction, the pad electrodes 23 as shown in the first to third embodiments having one-to-one correspondence to the mirror drive electrodes 22 are made unnecessary. Only pad electrodes 36 for applying voltage to the drive switches 26 from the variable voltage source 25 and pad electrodes 36 for transmitting signals for controlling the second control section 30 from the first control section 29 are required here.

Accordingly, the number of pad electrodes is remarkably reduced and implementation is made unnecessary of several hundreds of wiring that are usually required in those electrostatic drive mirror apparatus having a large number of electrodes. Thus downsizing, a substantial reduction in packaging cost and a shorter manufacturing time become possible and at the same time the electrostatic drive mirror apparatus having an improved reliability can be achieved.

While, in the present embodiment, the holding capacitor 27 has been shown as that formed underneath the mirror drive electrode 22, it is naturally also possible to form it underneath the signal wiring 24 as shown in the third embodiment. Further, while the first control section 29 in the present embodiment has been shown as that provided external to the electrostatic mirror chip, the first control section 29 can be provided also within the electrostatic mirror chip so as to form all except the variable voltage source 25 on one semiconductor substrate. By such construction, the pad electrode 36 for transmitting signals from the first control section 29 to the second control section 30 also becomes unnecessary so that a further downsizing and higher reliability are expected.

(Fifth Embodiment)

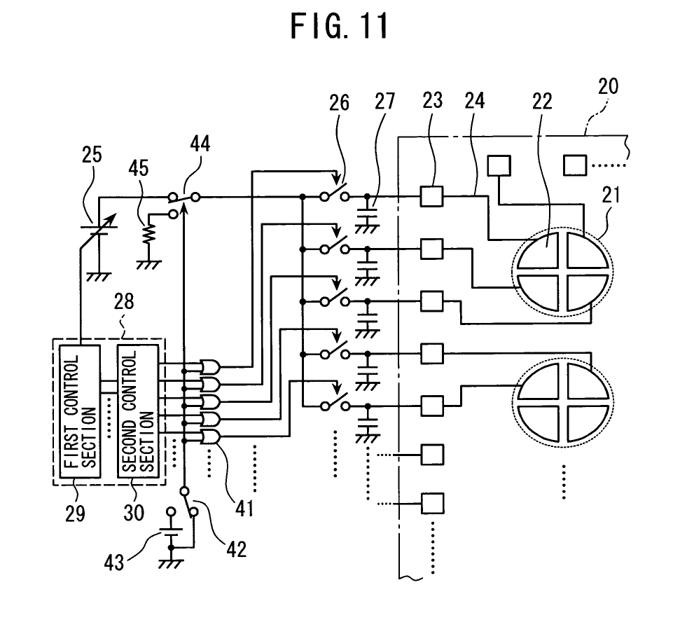

A fifth embodiment of the invention will now be described. The present embodiment relates to electrostatic drive mirror apparatus which can be readily initialized. The electrostatic drive mirror apparatus according to the present embodiment is shown in FIG. 11. FIG. 11 includes: 21, electrostatic drive mirrors that are two-dimensionally arrayed and variably operated by electrostatic drive; 22, mirror drive electrodes for driving the electrostatic drive mirrors 21; 23, pad electrodes for applying drive voltages from an external source; and 24, signal wiring for electrically connecting the mirror drive electrodes 22 and pad electrodes 23 to transmit drive signals to the mirror drive electrodes 22. Four mirror drive electrodes 22 are disposed to drive one electrostatic drive mirror 21. Here, the mirror drive electrodes 22, pad electrodes 23, and signal wiring 24 are formed as an electrostatic mirror drive section on one semiconductor substrate 20. The electrostatic mirror drive section is coupled to the electrostatic drive mirror 21 with a separation of predetermined distance. Thus coupled electrostatic mirror drive section and electrostatic drive mirror 21 are similarly referred to as an electrostatic mirror chip.

Formed at the outside of this electrostatic mirror chip are: a variable voltage source 25 for supplying drive voltage to the electrostatic mirror drive section; drive switches 26 for controlling and driving the applied drive voltage to the electrostatic mirror drive section; holding capacitor 27 for holding the applied drive voltage; and a control section 28 for controlling the variable voltage source 25 and drive switches 26. Here, the control section 28 is constituted by a first control section 29 and a second control section 30, where the first control section 29 is to control the variable voltage source 25 and the second control section 30 and for example contains D/A converter, high-voltage resisting amplifier, etc. The second control section 30, on the other hand, effects control of the drive switches 26. It is constituted for example by a shift register or decoder and is controlled by the first control section 29 which is synchronized.

Further, the present embodiment is provided with 2-input OR circuits as the control logic circuit for controlling the switching of the drive switches 26. One of the inputs to the 2-input OR circuit 41 is the output from the second control section 30 for example of shift register or decoder. Further, the other input to the 2-input OR circuit 41 is either a ground potential or potential of a power supply 43 for imparting “H” level to be switched by changeover switch 42. Furthermore, the electrostatic drive mirror apparatus is constructed as also including a discharge switch 44 for discharging stored charge accumulated at the holding capacitor 27, and a limiting resistor 45. The construction of the other portions and fundamental driving manner of the electrostatic drive mirror are similar to the foregoing embodiments.

The operation of this embodiment is different from the foregoing embodiments when the electrostatic drive mirror apparatus is to be initialized. In particular, when the electrostatic mirrors are normally driven, the changeover switch 42 is connected toward the ground and the discharge switch 44 toward the variable voltage source 25. Since the input level to the 2-input OR circuit 41 by the changeover switch 42 thus is “L” level, signals from the second control section 30 consisting of shift register or decoder are outputted without change to the output of the 2-input OR circuit 41. In other words, the switching control of the drive switches 26 depends on the output signals of the second control section 30. Since, on the other hand, the discharge switch 44 is connected toward the variable voltage source 25, a desired drive voltage from the variable voltage source 25 arbitrarily set by the first control section 29 is applied to the drive switches 26. Accordingly, desired drive voltage from the variable voltage source 25 is transmitted and applied to the electrostatic mirror drive section through the drive switches 26 at desired timings by the output signals of the second control section 30. The electrostatic drive mirrors 21 are driven by such drive voltage.

By contrast, when all electrostatic drive mirrors 21 are to be set to initial state, the changeover switch 42 is connected toward the power supply 43, and the discharge switch 44 toward the ground through the limiting resistor 45. Since the changeover switch 42 is connected toward the power supply 43, the input level to the 2-input OR circuit 41 by the changeover switch 42 becomes “H” level. The output of the 2-input OR circuit 41 is continuously forced to be “H” level so that it does no longer depends on the output of the second control section 30. Accordingly, the drive switches 26 are continuously turned ON and brought to their closed state so that the stored charges accumulated at the holding capacitors 27 are discharged to the ground through the drive switches 26, discharge switch 44 and limiting resistor 45. Here the limiting resistor 45 is to limit the discharging current flowing from each holding capacitor 27 when the respective drive switches 26 are simultaneously brought to their closed state.

By a series of these operations, all mirror drive electrodes 22 are brought to a ground potential so that all the electrostatic drive mirrors 21 are initialized. In this manner, according to the present embodiment, initialization of the electrostatic drive mirror apparatus can be performed very easily.

The control logic circuit of the present embodiment has been shown as but not limited to one using the 2-input OR circuit 41 and changeover switch 42. It is naturally also possible to use any construction as far as a similar function as the present embodiment is provided. Further, one using the limiting resistor 45 to limit the discharging current of stored charge at the holding capacitor 27 has been shown in the present embodiment. However, it can be omitted for example when the number of holding capacitors 27, i.e., number of electrostatic drive mirrors 21 is small or when no problem is caused by heating of package to be used or allowable current of the wiring. Further, the initial state setting means consisting of the control logic circuit using 2-input OR circuit 41, the changeover switch 42, discharge switch 44 and limiting resistor 45 is naturally applicable to the above first to fourth embodiments. Further such means can be constructed by discrete parts or be constructed together with other components on one semiconductor substrate.

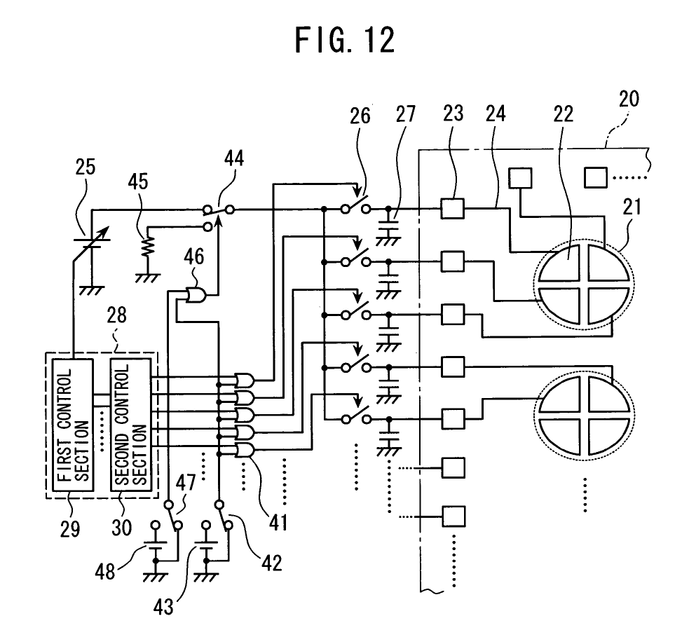

Further, in the above embodiment, all the holding capacitors are lumped together to be caused to discharge the stored charges so that all the electrostatic drive mirrors are initialized at once. In addition to the lumped initialization, however, it is also possible to selectively initialize only those desired electrostatic drive mirrors individually. Such construction is shown in FIG. 12 as a modification of the fifth embodiment. As shown in FIG. 12, this modification additionally includes 2-input OR circuit 46 to one input terminal of which a ground potential or the potential of the power supply 43 for providing “H” level to be switched by the changeover switch 42 is inputted. A ground potential or the potential of a power supply 48 for providing “H” level to be switched by a changeover switch 47 is inputted to the other input terminal thereof. The switching of the discharge switch 44 is controlled by the output of the 2-inpt OR circuit 46.

When the electrostatic drive mirrors are normally driven in thus constructed modification, the changeover switches 42 and 47 are connected toward the ground and the discharge switch 44 toward the variable voltage source 25. When on the other hand desired electrostatic drive mirrors are to be individually initialized, the changeover switch 42 is connected toward the ground and at the same time the changeover switch 47 is switched to be connected to the power supply 48 in synchronization with timing at which any one of the drive switches 26 connected to the desired electrostatic drive mirrors is turned ON. The discharge switch 44 is thereby connected to the ground through the limiting resistor 45 at such timing so that the stored charge of the holding capacitor 27 connected to the desired electrostatic drive mirror is discharged through the limiting resistor 45. Selective initialization of desired electrostatic drive mirrors thus becomes possible.

(Sixth Embodiment)

A sixth embodiment of the invention will now be described. In the electrostatic drive mirror apparatus as described in the above first to fifth embodiments, an intermittent, optional voltage is applied to all of the mirror drive electrodes by one unit of variable voltage source through drive switches controlled by the control section so as to drive a plurality of electrostatic drive mirrors. If the number of mirror array is increased, however, the voltage application cycle to each mirror drive electrode becomes longer, causing an increase of time during which no voltage is applied. In such a case, an increased holding capacitance is considered as measures. If the holding capacitance is increased, however, a considerable time is required in charging/discharging and as a result it is possible that a considerable amount of time is required to change the posture of the electrostatic drive mirror. The driving ability thereof is also concerned about.

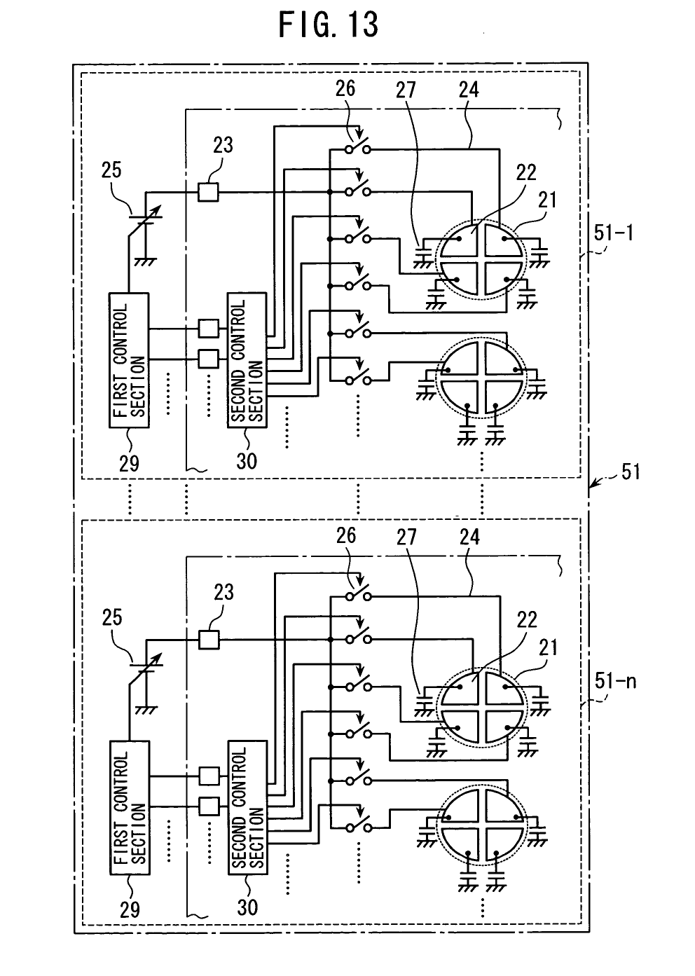

This embodiment is constructed by considering these concerned matters. FIG. 13 shows the electrostatic drive mirror apparatus according to the present embodiment. In FIG. 13, numerals 51-1 to 51-n each are an electrostatic drive mirror apparatus unit which is obtained by forming the electrostatic drive mirror apparatus described in the fourth embodiment shown in FIG. 10 into a unit. A plurality of units 51-1, to 51-n are arranged to form an electrostatic drive mirror apparatus 51 anew. Here, in constructing the electrostatic drive mirror apparatus 51 having a large number of mirrors by arranging the plurality of units, the number of electrostatic drive mirrors in each electrostatic drive mirror apparatus unit formed as a unit is limited by considering for example its driving capability. In the driving method, it suffices to synchronize the respective units and effect unit-by-unit drive. Naturally, each electrostatic drive mirror apparatus unit formed as a unit sufficiently possesses a function as an electrostatic drive mirror apparatus.

By such construction, it is possible to quicken the voltage application cycle to the mirror drive electrodes and at the same time an optimum holding capacitance value and voltage application cycle can be achieved.

The present embodiment has been described as but not limited to one in which the electrostatic drive mirror apparatus described in the fourth embodiment is formed into a unit. It is obvious that the present embodiment is applicable by forming the electrostatic drive mirror apparatus of the above described other embodiments into a unit. Further, while a description has been given with respect to the case where the number in mirror array is increased, it is naturally also possible to use the construction consisting of units as described in the present embodiment irrespective of the number of mirror arrays.

As has been described by way of the above embodiments, it is possible according to the first aspect of the invention to stably apply optional voltages to a plurality of mirror drive electrodes from a single variable voltage source through an intermittent switching of the drive switches. Further, since the holding capacitor has a retaining and storing function of the drive voltage of the electrostatic drive mirrors, it is possible to achieve an electrostatic drive mirror apparatus capable of stable and reliable operation by imparting a self-retaining characteristic to the electrostatic drive mirrors so as to remarkably reduce the number of drive voltage sources. According to the second and third aspects, an electrostatic drive mirror apparatus having self-retaining characteristic and capable of stable and reliable operation can be achieved by a simple construction and manufacturing method. According to the fourth aspect, since the drive switches, holding capacitor, and at least a part of the control section are formed on the same one semiconductor substrate, an electrostatic drive mirror apparatus having self-retaining characteristic and capable of stable operation with a remarkably reduced number of drive voltage sources can be achieved in a smaller size and at lower costs. According to the fifth aspect, since the holding capacitor is formed on the same one semiconductor substrate with the electrostatic mirror drive section, an electrostatic drive mirror apparatus capable of stable operation and reliable operation can be achieved in a smaller size. According to the sixth aspect, an electrostatic drive mirror apparatus can be readily constructed and fabricated by using discrete parts or the like without harming its function.

According to the seventh aspect, since the drive switches and at least a part of the control section are formed on the same one semiconductor substrate, the electrostatic drive mirror apparatus can be achieved in a smaller size and at lower costs. According to the eighth aspect, since only the control section is provided externally to the electrostatic mirror drive section, the electrostatic drive mirror apparatus can be achieved in a smaller size and at lower costs and as capable of stable operation and reliable operation. According to the ninth aspect, since the drive switches, holding capacitor and at least a part of the control section are formed on the same one semiconductor substrate with the electrostatic mirror drive section, a one-chip construction becomes possible and the electrostatic drive mirror apparatus can be achieved in a smaller size and at lower costs and as capable of stable operation and reliable operation. According to the tenth and eleventh aspects of the invention, since an electrostatic mirror drive section having self-retaining characteristic can be formed on one semiconductor substrate, the electrostatic drive mirror apparatus can be achieved in a smaller size and at lower costs and as capable of stable operation and reliable operation. According to the twelfth to fourteenth aspects, the electrostatic drive mirror apparatus can be achieved as capable of being readily initialized. According to the fifteenth to twentieth aspects, it is possible to achieve an electrostatic drive mirror apparatus which is capable of stable operation at high speed even when the number of electrostatic drive mirror arrays is increased.

What is claimed is:

1. An electrostatic drive mirror apparatus comprising:
electrostatic drive mirrors to be variably operated by electrostatic drive;
an electrostatic mirror drive section formed on one semiconductor substrate, including at least mirror drive electrodes for driving the electrostatic drive mirrors and signal wirings for applying drive voltage on the mirror drive electrodes;
a variable voltage source for supplying voltage from an external source to the electrostatic mirror drive section;
drive switches for controlling and driving applied voltages from said variable voltage source to said electrostatic mirror drive section;
holding capacitors for retaining the applied voltage to said electrostatic mirror drive section; and
a control section for controlling at least said drive switches and said variable voltage source.

2. The electrostatic drive mirror apparatus according to claim 1, wherein said drive switches, said holding capacitors and said control section are provided externally to said electrostatic mirror drive section.

3. The electrostatic drive mirror apparatus according to claim 2, wherein said drive switches, said holding capacitors and said control section are respectively formed a discrete member.

4. The electrostatic drive mirror apparatus according to claim 2, wherein said drive switches, said holding capacitors, and at least a part of said control section are disposed on the same one semiconductor substrate.

5. The electrostatic drive mirror apparatus according to claim 1, wherein said drive switches and said control section are provided externally to said electrostatic mirror drive section, and wherein said holding capacitors are disposed on the same one semiconductor substrate with said electrostatic mirror drive section.

6. The electrostatic drive mirror apparatus according to claim 5, wherein said drive switches and said control section are respectively formed as a discrete member.

7. The electrostatic drive mirror apparatus according to claim 5, wherein said drive switches and at least a part of said control section are disposed on the same one semiconductor substrate.

8. The electrostatic drive mirror apparatus according to claim 1, wherein said drive switches and said holding capacitors are disposed on the same one semiconductor substrate with said electrostatic mirror drive section, and wherein said control section is provided externally to said electrostatic mirror drive section.

9. The electrostatic drive mirror apparatus according to claim 1, wherein said drive switches and said holding capacitors and at least a part of said control section are disposed on the same one semiconductor substrate with said electrostatic mirror drive section.

10. The electrostatic drive mirror apparatus according to any one of claims 5 to 9, wherein said holding capacitors are disposed underneath said signal wirings of said electrostatic mirror drive section.

11. The electrostatic drive mirror apparatus according to any one of claims 5 to 9, wherein said holding capacitors are disposed underneath said mirror drive electrodes of said electrostatic mirror drive section.

12. The electrostatic drive mirror apparatus according to any one of claims 1 to 9, further comprising:
a control logic circuit having a function for effecting control to close said drive switches all together;
a discharging switch for discharging accumulated charges of said holding capacitors; and
a limiting resistor for limiting discharging current.

13. The electrostatic drive mirror apparatus according to claim 10, further comprising:
a control logic circuit having a function for effecting control to close said drive switches all together;
a discharging switch for discharging accumulated charges of said holding capacitors; and
a limiting resistor for limiting discharging current.

14. The electrostatic drive mirror apparatus according to claim 11, further comprising:
a control logic circuit having a function for effecting control to close said drive switches all together;
a discharging switch for discharging accumulated charges of said holding capacitors; and
a limiting resistor for limiting discharging current.

15. An electrostatic drive mirror apparatus comprising a plurality of units, each unit comprising the electrostatic drive mirror apparatus according to any one of claims 1 to 9.

16. An electrostatic drive mirror apparatus comprising a plurality of units, each unit comprising the electrostatic drive mirror apparatus according to claim 10.

17. An electrostatic drive mirror apparatus comprising a plurality of units, each unit comprising the electrostatic drive mirror apparatus according to claim 11.

18. An electrostatic drive mirror apparatus comprising a plurality of units, each unit comprising the electrostatic drive mirror apparatus according to claim 12.

19. An electrostatic drive mirror apparatus comprising a plurality of units, each unit comprising the electrostatic drive mirror apparatus according to claim 13.

20. An electrostatic drive mirror apparatus comprising a plurality of units, each unit comprising the electrostatic drive mirror apparatus according to claim 14.
